(19) United States
(12) Patent Application Publication
(10) Pub. No.: US 2018/0061145 A1
(43) Pub. Date: Mar. 1, 2018

(54) PARKING SPACE MANAGEMENT SYSTEM AND METHOD

(71) Applicant: PINK PARK LTD., Kfar Saba (IL)

(72) Inventor: Tomer Blustein, Kfar Saba (IL)

(73) Assignee: PINK PARK LTD., Kfar Saba (IL)

(21) Appl. No.: 15/801,524

(22) Filed: Nov. 2, 2017

Related U.S. Application Data
(63) Continuation-in-part of application No. PCT/IL2016/050461, filed on May 3, 2016.

(30) Foreign Application Priority Data
May 4, 2015 (IL) 238624

(51) Int. Cl. G07B 15/02; G08G 1/14; E05F 15/76

(52) U.S. Cl. CPC G07B 15/02; G06Q 10/02; E05F 15/76; G08G 1/14

(57) ABSTRACT

The present invention relates to a system of managing a parking space, comprising: a) a server for managing and controlling the access of vehicles into the parking space; b) at least one beacon associated with a passage gate at a passage point for transmitting a wireless signal(s); c) an access control module adapted to open/close said passage gate and accordingly to notify the state of said passage gate; and d) a user terminal communication device adapted to receive and identify said wireless signals, and accordingly to notify said server and/or said access control module upon the identification of said at least one beacon, thereby enabling said server and/or said access control module to perform parking related tasks.

### FIELD OF THE INVENTION

The present invention relates to the field of parking space management systems. More particularly, the invention relates to a method and system of providing automatic access control and usage of a parking space.

### BACKGROUND OF THE INVENTION

Conventional parking lot payment methods typically involve a kiosk that produces tickets that need to be manually paid by the car's driver or other parking lot user. Moreover, usually the parking lot user needs to keep a parking lot ticket, and to pay it at the exit from the parking lot. These payment systems can be inconvenient for users parking in the lot due to reasons, such as lost tickets, time consumed, etc. Moreover conventional systems are highly expensive and therefore unaffordable to many parking lots. Therefore, there is a need for improved parking lot management systems that addresses some or all of the drawbacks of conventional systems.

It is an object of the present invention to provide a system which is capable of automatically identifying a driver attempting to enter/exit a parking space.

It is another object of the present invention to provide a system which is capable of automatically charging a parking space user for the parking time.

Other objects and advantages of the invention will become apparent as the description proceeds.

### SUMMARY OF THE INVENTION

The present invention relates to a system of managing a parking space, comprising:
a) a parking space management server for managing and controlling the access of vehicles into the parking space;
b) at least one beacon associated with a passage gate at a passage point for transmitting a wireless signal(s);
c) an access control module adapted to open/close said passage gate and to notify the current state of said gate, whether said gate is in an open or close state; and
d) a user terminal communication device adapted to receive and identify said wireless signals, and accordingly to notify said parking space management server and/or said access control module upon the identification of said at least one beacon, thereby enabling said parking space management server and/or said access control module to perform parking related tasks, wherein said tasks include opening the corresponding passage gate and/or recording the actual passage of the vehicle through said passage point.

According to an embodiment of the invention, the system further comprises a gate sensor adapted to detect the status of the gate, wherein the detection of an open gate triggers the transmitting of a wireless signal(s) of at least one beacon associated with the passage gate that corresponds to the passage point.

According to an embodiment of the invention, at least one of the vehicle detection sensor is adapted to detect the actual passage of a vehicle through the passage point after and/or during crossing said passage gate, wherein said detection triggers the transmitting of a wireless signal by at least one beacon associated with the passage gate that corresponds to the said passage point.

According to an embodiment of the invention, the user terminal communication device is adapted to approximate the distance between the user terminal communication device and the at least one of the beacons location, based on the wireless signal strength of said beacon(s).

According to an embodiment of the present invention, at least one of the vehicle detection sensors is a pre-passage point vehicle detection sensor adapted to detect the presence of a vehicle at a specific passage point of the parking space prior to the passage of said point, wherein the detection of a vehicle at said specific passage point triggers the transmitting of a first wireless signal by a first beacon associated with an entrance gate that corresponds to said entrance point. According to an embodiment of the invention, the notification of the first beacon is used by the server to provide instruction to the access control module to open the corresponding passage gate and thereby to allow the vehicle to enter/exit the parking sp ace.

According to an embodiment of the present invention, at least one of the vehicle detection sensors is a meta-passage point vehicle detection sensor adapted to detect the presence of a vehicle after crossing said passage gate, wherein the detection of a vehicle by said meta-passage vehicle detection sensor triggers the transmitting of a second wireless signal by a second beacon. According to an embodiment of the invention, the notification of the second beacon is used by the server to verify the actual passage of the vehicle through the passage point.

According to an embodiment of the invention, the access control module closes the gate whenever the exterior vehicle detection sensor detects no vehicle for a predetermined period of time.

According to an embodiment of the invention, the instruction, to the access control module, to open the corresponding entrance gate are provided by the server via the user terminal communication device.

According to an embodiment of the present invention, the notification of the at least one beacon as identified by the user terminal communication device are communicated to the server via said user terminal communication device.

According to an embodiment of the present invention, the notification of the at least one beacon as identified by the user terminal communication device are provided to the server via the access control module.

According to an embodiment of the present invention, the notification of the at least one beacon are identified by the access control module and are provided to the server via the access control module.

According to an embodiment of the present invention, the system further comprises registration data representing users and/or vehicles registered/allowed to park in the parking space, thereby enabling said registered/allowed users/vehicles to automatically access the parking space upon detection of user terminal communication devices associated with said registered/allowed users/vehicles. For example, the registration data can be stored in the access control module or in a database/memory associated with said access control module. According to an embodiment of the present invention, the database/memory associated with the access control module is part of a local computer system adapted to collect data from a plurality of entrance gate associated with the parking space. In some embodiments, the registration data is stored in the server.

According to an embodiment of the present invention, at least one of the beacons includes a receiver adapted to receive remote control signals from the user terminal communication device or from a car dedicated beacon located in the vehicle. The car dedicated beacon can be powered by the vehicle's power source and/or by an internal power sources such as a battery.

According to an embodiment of the invention, the car dedicated beacon is adapted to communicate with the user terminal communication device, thereby enabling to detect whether a driver is being presence in the vehicle and/or whether the driver is being present a in a vehicle while engine of said vehicle is working.

According to an embodiment of the present invention, the car dedicated beacon is adapted to communicate with the at least one beacon in order to notify the server to provide instruction to open the gate, thereby enabling the vehicle to enter/exit the parking space and enabling the server to provide the parking duration of said vehicle in the parking space.

According to an embodiment of the present invention, the server adapted to keep count and manage the number of the entering and exiting vehicles to/from the parking space, thereby enabling to provide real-time information about the currently available parking spots in the parking space and accordingly to disable access to the parking space when it becomes fully occupied. According to an embodiment of the present invention, the server may notify the user terminal communication device whenever a specific parking space is fully occupied.

According to an embodiment of the present invention, the user terminal communication device is selected from the group consisting of: smartphone, media center installed in the vehicle, wearable computing device, tablet, laptop, portable computer.

According to an embodiment of the present invention, the at least one of the beacon includes an activation switch, thereby enabling a human operator to active said beacon. For example, the activation switch is configured by hardware (e.g., push button), software or any combination thereof (e.g., virtual button on a touch screen).

According to an embodiment of the present invention, the system further comprises a billing module for enabling to automatically charge users of the terminal communication device according to data gathered from the at least one beacon, wherein said data reflects the presence duration of a user's vehicle in the parking space.

In another aspect, the present invention relates to a method of managing a parking space, comprising:
a) Providing a parking space management server for managing and controlling the access of vehicles into the parking space;
b) Providing at least one vehicle detection sensor adapted to detect the presence of a vehicle at a specific passage point of the parking space, wherein the detection of a vehicle at said specific passage point triggers the transmitting of wireless signal(s) by at least one beacon associated with a passage gate at said passage point;
c) Providing an access control module adapted to open/close said passage gate and to notify the current state of said gate, whether said gate is in an open or close state;
d) Providing a user terminal communication device adapted to receive and identify said wireless signals, and accordingly to notify said parking space management server and/or said access control module upon the identification of said at least one beacon, thereby enabling said parking space management server and/or said access control module to perform parking related tasks, wherein said tasks include opening the corresponding passage gate and/or recording the actual passage of the vehicle trough said passage point.

According to an embodiment of the present invention, the method further comprises detecting the status of the gate, and whenever said gate is open transmitting a wireless signal(s) of at least one beacon associated with the passage gate that corresponds to the passage point.

According to an embodiment of the present invention, at least one of the vehicle detection sensor is used for detecting the actual passage of a vehicle through the passage point after and/or during crossing said passage gate, wherein said detection triggers the transmitting of a wireless signal by at least one beacon associated with the passage gate that corresponds to the said passage point.

According to an embodiment of the present invention, the method further comprises approximating the distance between the user terminal communication device and the at least one of the beacons location, based on the wireless signal strength of said beacon(s).

According to an embodiment of the present invention, the method further comprises enabling registered/allowed users and/or vehicles to automatically access the parking space upon detection of user terminal communication devices associated with said registered/allowed users/vehicles.

According to an embodiment of the present invention, the method further comprises enabling at least one beacon to receive remote control signals from the user terminal communication device or from a car dedicated beacon located in the vehicle.

According to an embodiment of the present invention, the method further comprises counting and managing the number of the entering and exiting vehicles to/from the parking space, thereby enabling to provide real-time information about the currently available parking spots in the parking space and accordingly to disable access to the parking space when it becomes fully occupied.

According to an embodiment of the present invention, the method further comprises managing parking reservations, thereby enabling drivers/users to book parking in advance in a specific parking space via the user terminal communication device or other enabled user interface. The management of the parking includes dynamically updating the parking pricing according to the current occupation status or based on statistical model according to known rush hours, thereby enabling to reduce or increase the pricing of the parking.

According to an embodiment of the present invention, the method further comprises automatically charging users of the terminal communication device according to data gathered from the at least one beacon, wherein said data reflects the presence duration of a user's vehicle in the parking sp ace.

In yet another aspect, the present invention relates to an access control module, comprising: a) a communication module for enabling to communicate with a parking space management server; and b) a short range communication unit (e.g., Bluetooth, NFC (near field communication), high or low frequency sound wave, magnetic field, RF, Wi-Fi, any combination thereof, etc.) for locally and wirelessly communicating with a user terminal communication device such as a smartphone. For example, the short range communication unit is a beacon such as the iBeacon which is an implementation of Bluetooth low-energy (BLE) wireless technology by Apple Inc.

According to an embodiment of the invention, the access control module further comprises a mechanical and/or electrical Radio Frequency (RF) remote control adapter.

According to an embodiment of the invention, the access control module is powered either by a battery or an external power source.

### BRIEF DESCRIPTION OF THE DRAWINGS

In the drawings:

FIG. 1 schematically illustrates a parking space management system, according to an embodiment of the invention; and

FIG. 2 schematically illustrates an access control module located at the parking space, according to an embodiment of the present invention.

### DETAILED DESCRIPTION OF THE INVENTION

Throughout this description the term “beacon” is used to indicate a short range wireless communication unit that can communicate (Receive and transmit wireless signals) with other devices, in particular to notify nearby devices of their presence, in addition a beacon may process data, perform computational task, etc. (depending on the configuration of each specific beacon). The beacon enables a smartphone (e.g., via a mobile app) or other user terminal communication device to perform actions when in close proximity to a beacon. For example, the beacons may include small, cheap Bluetooth and/or WiFi transmitters, and an application installed on a smartphone (i.e., a mobile app) listens out for signals transmitted by these beacons and respond accordingly when the smartphone comes into range. In other words, mobile apps may listen for signals from beacons in the physical world and react accordingly. In particular, beacons allow mobile apps to understand their position on a micro-local scale, and accordingly to deliver notifications based on location.

Throughout this description the term “parking space” is used to indicate a single/private parking spot, plurality of parking spots in a parking lot, or other parking arrangements.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

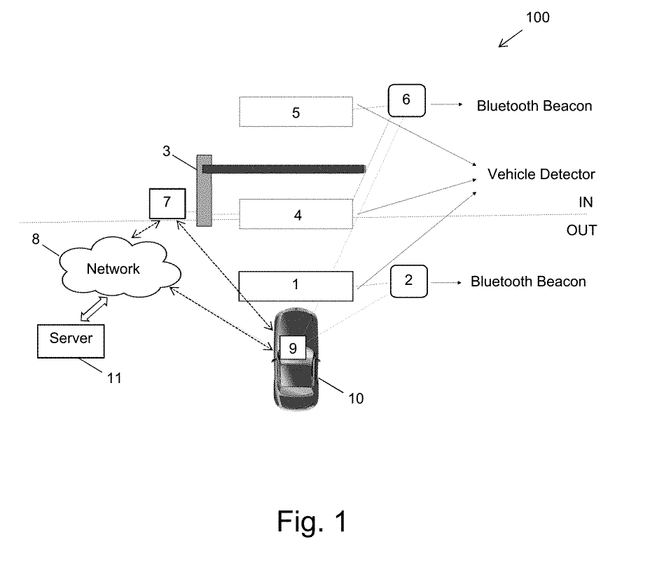

FIG. 1 schematically illustrates a parking space management system 100, according to an embodiment of the invention. System 100 comprises a parking space management server 11, a parking space pre-passage vehicle detection sensor 1 and a corresponding beacon 2, a parking space meta-passage vehicle detection sensor 5 and a corresponding beacon 6, a controllable gate/barrier 3 and a corresponding beacon 12, an access control module 7 and a user terminal communication device 9.

Beacons 2, 6 and 12 are configured to transmit a wireless signal(s) (e.g., Bluetooth, NFC, high or low frequency sound wave, magnetic field, RF, Wi-Fi, any combination thereof etc.) with specific data. In some embodiments the signal(s) of each beacon may change over time and are synchronized offline with server 11 by a preset shared key and/or method. In some embodiments the signal(s) of each beacon may change over time and are synchronized online with server 11 via access control module 7 and/or via terminal communication device 9.

In some embodiments sensor 1 enables to detect the presence of a vehicle at a specific passage point of a parking space, wherein the detection of the vehicle at the specific passage point triggers the transmitting of a first wireless signal(s) by the corresponding beacon 2 (e.g., Bluetooth, NFC, high or low frequency sound wave, magnetic field, RF, Wi-Fi, any combination thereof etc.). Beacon 2 is associated with gate 3 that corresponds to at this specific passage point. Sensor 5 enables to detect the passage of a vehicle 10 through the passage point after crossing the gate 3. The detection of a vehicle by sensor 5 triggers the transmitting of a second wireless signal(s) by the corresponding beacon 6.

The sensors 1 and 5 can be RFID reader, IR sensors, mechanical sensors, video sensors, presence sensors, optical sensors, temperature sensors, magnetic field sensors, electrical field sensors, sound sensors, pressure sensors, light sensors, any other types of sensors, or any combination thereof.

The access control module 7 enables to open/close gate 3 and, accordingly to report server 11 the current state of gate 3, whether it is in an open or close state. When open, gate 3 may trigger the transmitting of a second wireless signal(s) by the corresponding beacon 12.

The communication between the access control module 7 and server 11 are performed via a direct communication channel such as over the Internet, cellular, LAN etc. allowing bidirectional flow of information between server 11 and access control module 7 and one or more databases associated with system 100.

According to an embodiment of the invention, server 11 is adapted to send alerts (e.g., via email, SMS, push notifications etc.) regarding failures of the at least one beacon and/or the access control module 7.

The user terminal communication device 9 enables to receive and identify the wireless signals generated by each beacons 2, 6 and 12, and accordingly to notify server 11 upon the identification of each of the beacons 2 or 6 or 12 by device 9 or by access control module 7. The user terminal communication device 9 enables to receive and identify the wireless signal strength generated by beacon 2 and approximate the distance between the user terminal communication device 9 and beacon 2, therefore allows to locate and attribute a specific user terminal communication device to a specific vehicle location (sensor 1). The notification of beacon 2 may be used by server 11 to provide instruction to the access control module 7, to open gate 3 and thereby to allow vehicle 10 to cross trough the passage point. The notification of beacon 12 may be used by server 11 to verify the actual opening of gate 3. The notification of beacon 6 may be used by server 11 to verify the actual passage of vehicle 10 through the passage point. The notification of beacons 6 and 12 may be used by server 11 to count the number of vehicles passing through gate 3. According to an embodiment of the present invention, the communication between device 9 and server 11 can be performed via a wide area network 8 such as the Internet.

According to an embodiment of the invention beacons 2, 6 and 12 enable to receive and identify wireless signals generated by the user terminal communication device 9 and accordingly to notify server 11 upon the identification of device 9 via access control module 7. Beacon 2 enables to receive and identify the wireless signal strength generated by the user terminal communication device 9 and approximate the distance between the user terminal communication device 9 and beacon 2, therefore allowing to locate and attribute a specific user terminal communication device to a specific vehicle location (sensor 1).

The sensitivity to receive and/or transmit the strength of wireless signal(s) may vary between different user terminal communication devices 9, due to variance in model, manufacturer, batch, protective casing, software version, firmware version, grip, unique ID, temperature, acceleration, orientation, geolocation, battery status, etc. Server 11 is adapted to automatically learn, calculate and normalize the sensitivity of each user terminal communication device 9 based on historical data collected by server 11 for a specific terminal communication device(s) 9. Server 11 might send user communication device 9 at least one normalizing sensitivity parameter allowing user communication device 9 to better approximate the distance between the user terminal communication device 9 and beacons 2 and/or 6 and/or 12. In some embodiments server 11 might send access control module 7 a normalizing receiving sensitivity parameter based on different user communication devices 9 to better approximate the distance between the user terminal communication device 9 as a transmitter to the receiving beacons 2 and/or 6 and/or 12.

According to an embodiment of the invention, the notification of each of the beacons 2, 6 and 12, as identified by the user terminal communication device 9, can be provided to server 11 by device 9 via the wide area network 8. Alternatively, of each of the beacons 2, 6 and 12, as identified by the user terminal communication device 9, can be provided to server 11 by access control module 7 via the wide area network 8.

Access control module 7 may close the gate whenever a sensor located at the gate area (e.g., an inductive loop vehicle detector as indicated by sensor 4 in the figure) no longer detects a vehicle after a previous detection session, or whenever sensor a sensor located at the gate area detects no vehicle for a predetermined period of time (e.g., 20 seconds).

According to an embodiment of the invention, the instruction to open gate 3 can be provided to access control module 7 by server 11 via the user terminal communication device 9 through a short range communication protocol (e.g., Bluetooth, NFC, high or low frequency sound wave, magnetic field, RF, Wi-Fi, any combination thereof etc.). Alterably, the instruction to open gate 3 can be provided to access control module 7 by server 11 via network 8.

According to an embodiment of the invention, server 11 utilizes a machine learning mechanism in order to decide which work flow would a specific user go through in order to pass through a certain gate. The decision can be based on one or more features such as user history, user device module, user device software version, temperature, gate history, real time data from the access control module etc.

According to some embodiments of the present invention, server 11 may hold or may have accesses to data about payment methods of users of the terminal communication devices, in order to allow system 100 to handle payments for parking space usage. For example, server 11 may include a billing module (not shown) for enabling to automatically charge users of the terminal communication device according to data gathered from the at least one beacon. Such gathered data may reflect the parking/presence duration of a user's vehicle within the parking space (e.g., by counting the entrance and exit times of a vehicle using the user terminal communication device and beacons). The billing module can be an integrated extension to server 11 in order to add billing and invoicing features to system 100.

According to an embodiment of the invention, system 100 further comprises an interface (not shown) for interfacing and communicating with external systems, in particular with an existing parking space system (e.g., a kiosk located at the parking space that produces parking tickets), thereby enabling to exchange data between such external systems and the parking space management server 11 and/or the user terminal communication device. The external systems and system 100 may work in parallel and independently with or without the exchange of data between them.

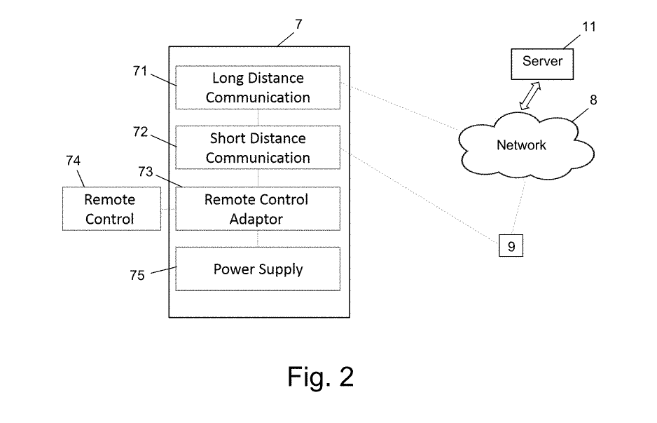

FIG. 2 shows an access control module that can be used in conjunction with the invention. The access control module illustrated in this figure is particularly convenient because it can be applied as an ad-on module to existing gates/barriers in parking spaces or parking lots without the need to carry out major alterations in the structure. The module generally indicated by numeral 7 in the figure comprises a communication module 71 for enabling to communicate with the parking space management server 11 via network 8 (e.g., the Internet), a short range communication unit 72 (e.g., Bluetooth, NFC, high or low frequency sound wave, magnetic field, RF, Wi-Fi, any combination thereof etc.) for locally and wirelessly communicating with the user terminal communication device 9. In some embodiments, access control module 7 further comprises a remote control adapter 73 configured to communicate with a corresponding remote control 74.

According to an embodiment of the present invention, server 11 is adapted to manage the access of vehicles to the parking space or parking lot. According to a specific embodiment of the present invention, as part of the management process, server 11 may inform the drivers or users of device 9 information such as availably of parking space, whether they are allowed to enter a specific parking space (e.g., when the parking space is fully occupied), pricing, etc.

As part of its operation, server 11 may perform the following operations: (i) confirms according the entrance and exit of vehicle to and from a parking space; (ii) controls the operation of one or more entrance gates to the parking space; (iii) registers/calculates the parking duration of each vehicle; and, (iv) manages the financial operations of system 100.

According to some embodiments of the invention, the management of the parking includes discriminative parking engine which would show different prices to different users based on discriminating features such as user history, the distance of a parking from a user requested destination, the user terminal communication model, user age, user car type etc.

FIGS. 1 and 2 and the above discussion were intended to provide a brief, general description of a suitable computing environment in which the invention may be implemented. While the invention is described in the general context of program modules that execute in conjunction with an application program that runs on an operating system on server 11 and on device 9, those skilled in the art will recognize that the invention may also be implemented in combination with other program modules and computer systems. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Unless otherwise indicated, the functions described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

As will be appreciated by the skilled person the arrangement described in the figures results in a system which is capable of automatically enabling a driver to enter/exit a parking space.

All the above description and examples have been given for the purpose of illustration and are not intended to limit the invention in any way. Many different mechanisms, methods of communication, electronic and logical elements can be employed, all without exceeding the scope of the invention.

1. A system of managing a parking space, comprising:
a) a parking space management server for managing and controlling the access of vehicles into the parking space;
b) at least one beacon associated with a passage gate at a passage point for transmitting a wireless signal(s);
c) an access control module adapted to open/close said passage gate and to notify the management server the current state of said gate, whether said gate is in an open or close state; and
d) a user terminal communication device adapted to receive and identify said wireless signals, and accordingly to notify said parking space management server and/or said access control module upon the identification of said at least one beacon, thereby enabling said parking space management server and/or said access control module to perform parking related tasks, wherein said tasks include opening the corresponding passage gate and/or recording the actual passage of the vehicle through said passage point.

2. The system according to claim 1, wherein the access control module is adapted to receive and/or identify and/or communicate with said at least one wireless signal, and accordingly to notify said parking space management server.

3. The system according to claim 1, further comprising at least one vehicle detection sensor adapted to detect the presence of a vehicle at a specific passage point of the parking space, wherein the detection of a vehicle at said specific passage point triggers the at least one beacon.

4. The system according to claim 3, wherein the data of the sensor is collected directly by a database associated with the access control module.

5. The system according to claim 3, wherein at least one of the vehicle detection sensor is adapted to detect the actual passage of a vehicle through the passage point after and/or during crossing said passage gate, wherein said detection triggers the transmitting of a wireless signal by at least one beacon associated with the passage gate that corresponds to the said passage point.

6. The system according to claim 5, wherein the data of the sensor is collected directly by a database associated with the access control module.

7. The system according to claim 1, further comprising a gate sensor adapted to detect the state of the gate.

8. The system according to claim 7, wherein the detection of an open/close state of the gate triggers the transmitting of a wireless signal(s) of at least one beacon associated with the passage gate that corresponds to the passage point.

9. The system according to claim 1, wherein the user terminal communication device is adapted to approximate the distance between the user terminal communication device and the at least one of the beacons location, based on the wireless signal strength of said beacon(s).

10. The system according to claim 9, wherein the user terminal communication device is adapted to better approximate the distance between the user terminal communication device and the at least one of the beacons location, based on at least one unique parameter received from the management server.

11. The system according to claim 10, wherein the at least one unique parameter received from the management server is calculated based on unique features of the terminal communication device such as manufacturer, model, software version, firmware version, unique ID, temperature, acceleration, orientation, geolocation, battery status, etc.

12. The system according to claim 10, wherein the at least one unique parameter received from the management server is calculated based on unique features of the at least one beacon such as model, software version, firmware version, temperature, acceleration, orientation, battery status, unique ID etc.

13. The system according to claim 10, wherein the at least one unique parameter received from the management server is calculated based on historical data collected in previous at least one session regarding at least one specific terminal communication device.

14. The system according to claim 10, wherein the at least one unique parameter received from the management server is calculated based on historical data collected in at least one previous session regarding at least one specified beacon.

15. The system according to claim 10, wherein the management server uses at least one algorithm to calculate the at least one unique parameter in an ongoing manner such as machine learning.

16. The system according to claim 1, wherein the access control module closes the gate whenever the at least one of the vehicle detection sensor detects no vehicle for a predetermined period of time.

17. The system according to claim 1, wherein the communication between the access control module and the server are performed via the user terminal communication device.

18. The system according to claim 1, wherein the communication between the access control module and the server are performed via direct communication channel allowing bidirectional flow of information between the server and the access control module and one or more associated databases.

19. The system according to claim 1, wherein the notification of the at least one beacon as identified by the user terminal communication device are communicated to the server via said user terminal communication device.

20. The system according to claim 1, wherein the notification of the at least one beacon as identified by the user terminal communication device are provided to the server via the access control module.

21. The system according to claim 1, wherein the server is adapted to send alerts regarding failures of the at least one beacon and/or the access control module.

22. The system according to claim 1, further comprising registration data representing users and/or vehicles registered/allowed to park in the parking space, thereby enabling said registered/allowed users/vehicles to automatically access the parking space upon detection of user terminal communication devices associated with said registered/allowed users/vehicles.

23. The system according to claim 22, wherein the registration data is stored in the access control module or in a database/memory associated with said access control module.

24. The system according to claim 23, wherein the database/memory associated with the access control module is part of a local computer system adapted to collect and push data from/to a plurality of gates associated with the parking space.

25. The system according to claim 22, wherein the registration data is stored in the server.

26. The system according to claim 1, wherein at least one beacon includes a receiver adapted to receive remote control signals from the user terminal communication device and/or from the access control module and/or from a car dedicated beacon located in the vehicle.

27. The system according to claim 26, wherein the car dedicated beacon is powered by the vehicle's power source.

28. The system according to claim 26, wherein the car dedicated beacon is adapted to communicate with the user terminal communication device, thereby enabling to detect whether a driver is being presence in the vehicle and/or whether the driver is being present a in a vehicle while engine of said vehicle is working.

29. The system according to claim 26, wherein the car dedicated beacon is adapted to communicate with the at least one beacon in order to notify the server to provide instruction to open the gate, thereby enabling the vehicle to enter/exit the parking space and enabling the server to provide the parking duration of said vehicle in the parking space.

30. The system according to claim 1, wherein the server adapted to keep count and manage the number of the entering and exiting vehicles to/from the parking space, thereby enabling to provide real-time information about the currently available parking spots in the parking space and accordingly to disable access to the parking space when it becomes fully occupied.

31. The system according to claim 30, wherein the server adapted to notify the user terminal communication device whenever a specific parking space is fully occupied.

32. The system according to claim 1, wherein the server adapted to manage parking reservations, thereby enabling drivers/users to book parking in advance in a specific parking space via the user terminal communication device.

33. The system according to claim 1, wherein the management of the parking includes dynamically updating the parking pricing according to the current occupation status or based on statistical model according to known rush hours, thereby enabling to reduce or increase the pricing of the parking.

34. The system according to claim 1, further comprising discriminative parking engine which would show different prices to different users based on discriminating features such as user history, the distance of a parking from a user requested destination, the user terminal communication model, user age, user car type etc.

35. The system according to claim 1, wherein the user terminal communication device is selected from the group consisting of: smartphone, media center installed in the vehicle, wearable computing device, tablet, laptop, portable computer.

36. The system according to claim 1, wherein at least one of the beacon includes an activation switch, thereby enabling a human operator to active said beacon.

37. The system according to claim 36, wherein the activation switch is configured by hardware, software or any combination thereof.

38. The system according to claim 1, further comprising a billing module for enabling to automatically charge users of the terminal communication device according to data gathered from the at least one beacon, wherein said data reflects the presence duration of a user's vehicle in the parking space.

39. The system according to claim 1, further comprising an interface for communicating with external systems, in particular with an existing parking space management and control system.

40. The system according to claim 1, wherein the server utilizes a machine learning mechanism in order to decide which work flow would a specific user go through in order to pass through a certain gate based on one or more features such as user history, user device module, user device software version, temperature, gate history, real time data from the access control module etc.

41. A method of managing a parking space, comprising:
a) Providing a parking space management server for managing and controlling the access of vehicles into the parking space;
b) Providing at least one beacon associated with a passage gate at a passage point for transmitting a wireless signal(s);
c) Providing an access control module adapted to open/close said passage gate and to notify the current state of said gate, whether said gate is in an open or close state;
d) Providing a user terminal communication device adapted to receive and identify said wireless signals, and accordingly to notify said parking space management server and/or said access control module upon the identification of said at least one beacon, thereby enabling said parking space management server and/or said access control module to perform parking related tasks, wherein said tasks include opening the corresponding passage gate and/or recording the actual passage of the vehicle trough said passage point.

42. The method according to claim 41, further comprising detecting the status of the gate, and whenever said gate is open transmitting a wireless signal(s) of at least one beacon associated with the passage gate that corresponds to the passage point.

43. The method according to claim 41, wherein at least one of the vehicle detection sensor is used for detecting the actual passage of a vehicle through the passage point after and/or during crossing said passage gate, wherein said detection triggers the transmitting of a wireless signal by at least one beacon associated with the passage gate that corresponds to the said passage point.

44. The method according to claim 41, further comprising approximating the distance between the user terminal communication device and the at least one of the beacons location, based on the wireless signal strength of said beacon(s).

45. The method according to claim 41, wherein the access control module closes the gate whenever the at least one of the vehicle detection sensor detects no vehicle for a predetermined period of time.

46. The method according to claim 41, wherein the communication between the access control module and the server are performed via the user terminal communication device.

47. The method according to claim 41, wherein the notification of the at least one beacon as identified by the user terminal communication device are communicated to the server via said user terminal communication device.

48. The method according to claim 41, wherein the notification of the at least one beacon as identified by the user terminal communication device are provided to the server via the access control module.

49. The method according to claim 41, wherein the notification of the at least one beacon is identified by the access control module and is provided to the server via the access control module.

50. The method according to claim 41, further comprising enabling registered/allowed users and/or vehicles to automatically access the parking space upon detection of user terminal communication devices associated with said registered/allowed users/vehicles.

51. The method according to claim 41, further comprising enabling at least one beacon to receive remote control signals from the user terminal communication device or from a car dedicated beacon located in the vehicle.

52. The method according to claim 51, wherein the car dedicated beacon is adapted to communicate with the user terminal communication device, thereby enabling to detect whether a driver is being presence in the vehicle and/or whether the driver is being present a in a vehicle while the engine of said vehicle is working.

53. The method according to claim 51, wherein the car dedicated beacon is adapted to communicate with the at least one beacon in order to notify the server to provide instruction to open the gate, thereby enabling the vehicle to enter/exit the parking space and enabling the server to provide the parking duration of said vehicle in the parking space.

54. The method according to claim 41, further comprising counting and managing the number of the entering and exiting vehicles to/from the parking space, thereby enabling to provide real-time information about the currently available parking spots in the parking space and accordingly to disable access to the parking space when it becomes fully occupied.

55. The method according to claim 54, further comprising notifying the user terminal communication device whenever a specific parking space is fully occupied.

56. The method according to claim 41, further comprising managing parking reservations, thereby enabling drivers/users to book parking in advance in a specific parking space via the user terminal communication device or other enabled user interface.

57. The method according to claim 56, wherein the management of the parking includes dynamically updating the parking pricing according to the current occupation status or based on statistical model according to known rush hours, thereby enabling to reduce or increase the pricing of the parking.

58. The method according to claim 41, further comprising automatically charging users of the terminal communication device according to data gathered from the at least one beacon, wherein said data reflects the presence duration of a user's vehicle in the parking sp ace.

59. The method according to claim 41, further comprising interfacing and communicating with external systems, in particular with an existing parking space system, thereby enabling to exchange data between said external systems and the parking space management and/or the user terminal communication device.
